(19) United States
(12) Patent Application Publication
(10) Pub. No.: US 2025/0308729 A1
(43) Pub. Date: Oct. 2, 2025

(54) RECTANGULAR WIRE AND PRODUCTION METHOD FOR SAME

(71) Applicant: AGC Inc., Tokyo (JP)

(72) Inventors: Masatoshi ABE, Tokyo (JP); Toru SASAKI, Tokyo (JP)

(73) Assignee: AGC Inc., Tokyo (JP)

(21) Appl. No.: 19/234,890

(22) Filed: Jun. 11, 2025

Related U.S. Application Data
(63) Continuation of application No. PCT/JP2023/044595, filed on Dec. 13, 2023.

(30) Foreign Application Priority Data
Dec. 15, 2022 (JP) 2022-200429

(51) Int. Cl. H01B 13/14; H01B 3/44; H01B 7/00; H01B 7/02

(52) U.S. Cl. CPC H01B 13/14; H01B 3/445; H01B 7/0009; H01B 7/02

(57) ABSTRACT

A rectangular wire including a rectangular conductor having a rectangular cross-section in a direction perpendicular to the axial direction, and a coating film of an insulating coating material formed by extrusion molding that directly covers the rectangular conductor around the entire peripheral direction, wherein the melt flow rate of the insulating coating material at 297° C. is within a range from 13 to 150 g/10 min., the average thickness of the coating film of the insulating coating material is within a range from 10 to 1,000 μm, the unbiased standard deviation of the thickness of the coating film of the insulating coating material along the axial direction of the rectangular wire is less than 0.06 mm, the insulating coating material contains a fluorine-containing copolymer having a tetrafluoroethylene-based unit and an ethylene-based unit, and in a winding test of the rectangular wire conducted in accordance with JIS 3216-3:2011, section 5.1.2 “Rectangular Wires”, the coating film of the insulating coating material does not detach from the rectangular conductor.

This application is a continuation application of International Application No. PCT/JP2023/044595, filed on Dec. 13, 2023, which claims the benefit of priority of Japanese Patent Application No. 2022-200429, filed on Dec. 15, 2022, the contents of which are incorporated herein by reference.

### TECHNICAL FIELD

The present invention relates to a rectangular wire and a production method for the same.

### BACKGROUND ART

Reducing the size and weight of vehicle equipment and the like used in automobiles, trains, and aircraft and the like is very desirable. As a result, the coating films of insulating coating materials of insulating wiring of electrical devices used in such vehicle equipment is preferably kept as thin as possible. Moreover, as the power output and voltage of electrical devices is increased, the insulating coating material requires superior insulation properties and powerful adhesion to the conductor.

If the conductor of an electric wire is made rectangular in shape, then compared with a circular wire, the space factor is higher when the wire is wound into a coil and the space occupied by the entire coil is reduced, which contributes to a reduction in the size of the electrical device. However, in the case of a rectangular conductor, formation of a uniform coating film of the insulating coating material is more difficult than in the case of a circular wire, and achieving satisfactory insulation properties can be problematic.

Patent Document 1 discloses a method for producing a rectangular wire in which by coating a rectangular conductor with a powder having an average particle size of at least 0.02 μm but not more than 150 μm of a melt-moldable fluororesin with a melting point of at least 100° C. but not more than 325° C. and having at least one type of functional group selected from the group consisting of carbonyl group-containing groups, a hydroxy group, an epoxy group and an isocyanate group, a coating film of an insulating coating layer with a thickness of 10 to 150 μm is formed around the outer periphery of the rectangular conductor.

### CITATION LIST

### Patent Document

Patent Document 1: Japanese Unexamined Patent Application, First Publication No. 2017-204410

### SUMMARY OF INVENTION

### Technical Problem

However, the production method disclosed in Patent Document 1 requires a powder preparation step and a baking step following application of the powder, meaning the productivity is problematically low. Further, another problem arises in that because a powder is applied, the surface smoothness of the coating film of the insulating coating material is low. Moreover, the ability of the coating film of the insulating coating material to conform and follow the shape of the rectangular conductor is poor, and when the rectangular wire is subjected to bending deformation, the coating film of the insulating coating material tends to wrinkle, or in some cases the coating film of the insulating coating material may detach from the rectangular conductor.

The present invention has an object of providing a rectangular wire that can be produced with good productivity, and exhibits excellent surface smoothness of the coating film of the insulating coating material and excellent conformability of the coating film of the insulating coating material to the rectangular conductor during bending deformation, and also providing a production method for the rectangular wire.

### Solution to Problem

The present invention has the following aspects.

[1] A rectangular wire including a rectangular conductor having a rectangular cross-section in a direction perpendicular to the axial direction, and a coating film of an insulating coating material formed by extrusion molding that directly covers the rectangular conductor around the entire peripheral direction, wherein the melt flow rate of the insulating coating material at 297° C. is within a range from 13 to 150 g/10 min., the average thickness of the coating film of the insulating coating material is within a range from 10 to 1,000 μm, the unbiased standard deviation of the thickness of the coating film of the insulating coating material along the axial direction of the rectangular wire is less than 0.06 mm, the insulating coating material contains a fluorine-containing copolymer having a tetrafluoroethylene-based unit and an ethylene-based unit, and in a winding test of the rectangular wire conducted in accordance with JIS 3216-3:2011, section 5.1.2 “Rectangular Wires”, the coating film of the insulating coating material does not detach from the rectangular conductor.
[2] The rectangular wire according to [1], wherein the cross-sectional area of the rectangular conductor is 2.6 mm² or greater.
[3] The rectangular wire according to [1] or [2], wherein the insulating coating material contains a crosslinking assistant having a plurality of unsaturated carbon bonds.
[4] The rectangular wire according to [3], wherein the insulating coating material is a crosslinked product having a crosslinked structure formed by the crosslinking assistant.
[5] The rectangular wire according to [4], wherein the result for a scrape abrasion test conducted in accordance with ISO 6722-1 is 2,000 repetitions or higher.
[6] A production method for a rectangular wire including a rectangular conductor having a rectangular cross-section in a direction perpendicular to the axial direction, and a coating film of an insulating coating material formed by extrusion molding that directly covers the rectangular conductor around the entire peripheral direction, the production method including a step of forming the insulating coating material, using an extruder fitted with a die, by melting a fluorine-containing copolymer and extruding the melted fluorine-containing copolymer from the die around the periphery of the rectangular conductor so that the melted fluorine-containing copolymer coats the periphery of the rectangular conductor, wherein the melt flow rate of the insulating coating material at 297° C. is within a range from 13 to 150 g/10 min., the average thickness of the coating film of the insulating coating material is within a range from 10 to 1,000 μm, the unbiased standard deviation of the thickness of the coating film of the insulating coating material along the axial direction of the rectangular wire is less than 0.06 mm, the fluorine-containing copolymer has a tetrafluoroethylene-based unit and an ethylene-based unit, and in a winding test of the rectangular wire conducted in accordance with JIS 3216-3:2011, section 5.1.2 “Rectangular Wires”, the coating film of the insulating coating material does not detach from the rectangular conductor.
[7] The production method for a rectangular wire according to [6], wherein the draw down ratio DDR calculated using formula 1 below is at least 0.5 but less than 10.0.

$$DDR = ( {D}_{A} - {C}_{A} ) / ( {F}_{A} - {C}_{A} ) \qquad Formula 1$$

In formula 1, D_{A} represents the area (mm²) of the die opening, C_{A} represents the area (mm²) of a cross-section of the rectangular conductor in a direction perpendicular to the axial direction, and F_{A} represents the area (mm²) of a cross-section of the rectangular wire in a direction perpendicular to the axial direction.

[8] The production method for a rectangular wire according to [6] or [7], wherein the cross-sectional area of the rectangular conductor is 2.6 mm² or greater.
[9] The rectangular wire or the production method for a rectangular wire according to any one of [1] to [8], wherein the melt flow rate of the insulating coating material at 297° C. is within a range from 15 to 130 g/10 min.
[10] The rectangular wire or the production method for a rectangular wire according to any one of [1] to [8], wherein the melt flow rate of the insulating coating material at 297° C. is within a range from 20 to 110 g/10 min.
[11] The rectangular wire or the production method for a rectangular wire according to any one of [1] to [8], wherein the melt flow rate of the insulating coating material at 297° C. is within a range from 30 to 90 g/10 min.
[12] The rectangular wire or the production method for a rectangular wire according to any one of [1] to [11], wherein the melt flow rate of the insulating coating material at 350° C. is within a range from 40 to 500 g/10 min.
[13] The rectangular wire or the production method for a rectangular wire according to any one of [1] to [11], wherein the melt flow rate of the insulating coating material at 350° C. is within a range from 60 to 300 g/10 min.
[14] The rectangular wire or the production method for a rectangular wire according to any one of [1] to [11], wherein the melt flow rate of the insulating coating material at 350° C. is within a range from 80 to 210 g/10 min.
[15] The rectangular wire or the production method for a rectangular wire according to any one of [1] to [14], wherein the average thickness of the coating film of the insulating coating material is within a range from 20 to 500 μm.
[16] The rectangular wire or the production method for a rectangular wire according to any one of [1] to [14], wherein the average thickness of the coating film of the insulating coating material is within a range from 50 to 200 μm.
[17] The rectangular wire or the production method for a rectangular wire according to any one of [1] to [16], wherein the unbiased standard deviation of the thickness of the coating film of the insulating coating material along the axial direction of the rectangular wire is 0.03 mm or less.
[18] The production method for a rectangular wire according to any one of [7] to [17], wherein the draw down ratio DDR is within a range from 0.5 to 5.
[19] The production method for a rectangular wire according to any one of [7] to [17], wherein the draw down ratio DDR is within a range from 0.8 to 1.5.

### Advantageous Effects of Invention

The present invention is able to provide a rectangular wire that can be produced with good productivity, and exhibits excellent surface smoothness of the coating film of the insulating coating material and excellent conformability of the coating film of the insulating coating material to the rectangular conductor during bending deformation, as well as providing a production method for the rectangular wire.

### DESCRIPTION OF EMBODIMENTS

The melt flow rate refers to the melt mass flow rate prescribed in JIS K 7210-1:2014 (corresponding with the International Standard ISO 1133-1:2011). In the following description, the melt flow rate is sometimes abbreviated as MFR. The measurement conditions for the MFR include a temperature of 297° C. and a load of 49 N, or a temperature of 350° C. and a load of 49 N.

The average thickness of the coating film of the insulating coating material is determined by measuring the thickness of the coating film of the insulating coating material on the long side of a rectangular cross-section in a direction perpendicular to the axial direction every 100 mm for a rectangular wire of length 5 m, and then calculating the arithmetic mean of those thickness measurements.

The unbiased standard deviation of the thickness of the coating film of the insulating coating material along the axial direction of the rectangular wire is determined by measuring the thickness of the coating film of the insulating coating material on the long side of a rectangular cross-section in a direction perpendicular to the axial direction every 100 mm for a rectangular wire of length 5 m, and then calculating the unbiased standard deviation from the results of those measurements.

The shearing stress of the insulating coating material refers to a value obtained by measurement using a conventional formula (for example, JIS K 7199:1999) in accordance with a die provided on an apparatus used for extrusion molding. In this description, the shearing stress refers to a value measured using a capillary die. Specifically, the shearing stress refers to a value measured in accordance with the method described in paragraphs [0073] to [0075] and [0079] to [0081] in Japanese Unexamined Patent Application, First Publication No. 2015-086364.

A “unit” of a polymer means a portion (polymer unit) derived from a monomer that is formed by polymerizing the monomer. The unit may be a unit formed directly by the polymerization reaction, or may be a unit in which a portion of the unit has been altered to a different structure by treating the polymer. In this description, a unit based on a monomer is sometimes referred to as a “monomer unit”.

### <<Rectangular Wire>>

The rectangular wire includes a rectangular conductor having a rectangular cross-section in a direction perpendicular to the axial direction, and a coating film of an insulating coating material formed by extrusion molding that directly covers the rectangular conductor around the entire peripheral direction. In a winding test of the rectangular wire of an embodiment of the present invention conducted in accordance with JIS 3216-3:2011, section 5.1.2 “Rectangular Wires”, the coating film of the insulating coating material does not detach from the rectangular conductor.

### <Rectangular Conductor>

The rectangular conductor is the core wire of the rectangular wire, and is a conductor that has a rectangular cross-section in a direction perpendicular to the axial direction. The material of the rectangular conductor may be any conventional material used as the core wire of electrical wiring, and examples include copper, tin, silver, gold, aluminum, and alloys of these metals. Among the various possibilities, from the viewpoint of the ease of formation of the rectangular conductor, copper is preferred.

The thickness of the rectangular conductor is, for example, within a range from 0.5 mm to 3.0 mm.

The width of the rectangular conductor is, for example, within a range from 1.0 mm to 5.0 mm.

Further, the ratio of the thickness relative to the width (thickness/width) of the rectangular conductor is preferably within a range from 0.1 to 3.0.

The thickness of the rectangular conductor refers to the length of the short side of a rectangular cross-section in a direction perpendicular to the axial direction. The width of the rectangular conductor refers to the length of the long side of a rectangular cross-section in a direction perpendicular to the axial direction.

The cross-sectional area of the rectangular conductor is preferably 2.6 mm² or greater, and more preferably 3.0 mm² or greater. There are no particular limitations on the upper limit for the cross-sectional area of the rectangular conductor, but a typical value is 15 mm².

The cross-sectional area of the rectangular conductor refers to the area of a cross-section in a direction perpendicular to the axial direction.

In those cases where the conformability of the coating film of the insulating coating material to the rectangular conductor during bending deformation is poor, the greater the cross-sectional area of the rectangular conductor becomes, the more likely wrinkling of the coating film of the insulating coating material or detachment of the coating film of the insulating coating material from the rectangular conductor is to occur during bending deformation of the rectangular wire. The rectangular wire of an embodiment of the present invention exhibits excellent conformability of the coating film of the insulating coating material to the rectangular conductor during bending deformation, and therefore offers greater applicability as the cross-sectional area of the rectangular conductor increases.

### <Coating Film of Insulating Coating Material>

The average thickness of the coating film of the insulating coating material is within a range from 10 to 1,000 μm or greater, and is preferably within a range from 20 to 500 μm, and more preferably from 50 to 200 μm. Provided the average thickness of the coating film is at least as large as the above lower limit, the coating film exhibits excellent tracking resistance. Provided the average thickness of the coating film is not greater than the above upper limit, the overall thickness of the rectangular wire can be kept thin, and the space occupied by the entire coil when the rectangular wire is wound into a coil can be reduced, which contributes to a reduction in the size of the electrical device.

The unbiased standard deviation of the thickness of the coating film of the insulating coating material along the axial direction of the rectangular wire (hereinafter, also referred to as simply the “thickness variation”) is less than 0.06 mm, and is preferably not more than 0.03 mm, and more preferably 0.01 mm or less. Provided the thickness variation of the coating film is less than (or not more than) the above upper limit, the cracking resistance during bending deformation and the tracking resistance are excellent.

The thickness variation of the coating film is preferably as small as possible, and may be zero. From the viewpoints of ease of production and yield, the thickness variation of the coating film is preferably 0.001 mm or greater.

The lower limit values and upper limit values mentioned above may be combined as appropriate.

The MFR of the insulating coating material at 297° C. is within a range from 13 to 150 g/10 min., preferably from 15 to 130 g/10 min., more preferably from 20 to 110 g/10 min., and even more preferably from 30 to 90 g/10 min.

The MFR of the insulating coating material at 350° C. is preferably within a range from 40 to 500 g/10 min., more preferably from 60 to 300 g/10 min., and even more preferably from 80 to 210 g/10 min.

Provided the MFR of the insulating coating material at either 297° C. or 350° C. is at least as high as the above lower limit, the surface smoothness of the coating film of the insulating coating material and the conformability of the coating film of the insulating coating material to the rectangular conductor during bending deformation can be enhanced. Provided the MFR of the insulating coating material at either 297° C. or 350° C. is no higher than the above upper limit, the strength of the coating film of the insulating coating material can be increased.

The shearing stress of the insulating coating material is preferably within a range from 0.1 to 105 kPa, more preferably from 1 to 75 kPa, and more preferably from 5 to 50 kPa. Provided the shearing stress of the insulating coating material is at least as high as the above lower limit, the uniformity of the thickness of the coating of the insulating coating material improves. Provided the shearing stress of the insulating coating material is no higher than the above upper limit, the adhesion with the conductor can be improved.

The insulating coating material contains a fluorine-containing copolymer having a tetrafluoroethylene-based unit (hereinafter, tetrafluoroethylene is sometimes abbreviated as “TFE”) and an ethylene-based unit (hereinafter, ethylene is sometimes abbreviated as “E”).

The insulating coating material may also contain one or more other components besides the fluorine-containing copolymer, provided the characteristics of the insulating coating material are not significantly impaired.

The amount of the fluorine-containing copolymer relative to the total mass of the insulating coating material is preferably at least 50% by mass, and more preferably at least 70% by mass, and may be 100% by mass.

### (Fluorine-Containing Copolymer)

The fluorine-containing copolymer has a TFE unit and an E unit. The fluorine-containing copolymer may be a fluorine-containing copolymer composed solely of TFE units and E units, or may be a fluorine-containing copolymer that has one or more other units besides the TFE unit and the E unit.

Examples of the other unit include a unit u1 based on a monomer having a fluorine other than the TFE unit, a unit u2 based on a monomer having a functional group (but excluding monomers having a fluorine), and a unit u3 based on a monomer having no fluorine other than the E unit (but excluding monomers having a functional group).

The monomer having a fluorine that forms the unit u1 is preferably a fluorine-containing compound having one polymerizable carbon-carbon double bond. Specific examples include fluoroolefins (such as vinyl fluoride, vinylidene fluoride, trifluoroethylene, hexafluoropropylene (hereinafter sometimes abbreviated as “HFP”), chlorotrifluoroethylene and hexafluoroisobutylene, but excluding TFE), perfluoro (alkyl vinyl ethers) (hereinafter sometimes abbreviated as “PAVE”), CF₂═CFOR^{f2}SO₂X¹ (wherein R^{f2} is a perfluoroalkylene group of 1 to 10 carbon atoms that may include an oxygen atom between carbon atoms, and X¹ is a halogen atom or a hydroxyl group), CF₂═CFOR^{f3}CO₂X² (wherein R^{f3} is a perfluoroalkylene group of 1 to 10 carbon atoms that may include an oxygen atom between carbon atoms, and X² is a hydrogen atom or an alkyl group of 1 to 3 carbon atoms), CF₂—CF(CF₂)ₚOCF=CF₂ (wherein p is either 1 or 2), fluoroalkylethylenes (hereinafter sometimes abbreviated as “FAE”), and fluorine-containing monomers having a cyclic structure (such as perfluoro (2,2-dimethyl-1,3-dioxole), 2,2,4-trifluoro-5-trifluoromethoxy-1,3-dioxole, and perfluoro (2-methylene-4-methyl-1,3-dioxolane)). A single monomer having a fluorine may be used alone, or a combination of two or more such monomers may be used.

In terms of achieving superior moldability for the fluorine-containing copolymer, the monomer having a fluorine that forms the unit u1 is preferably at least one compound selected from the group consisting of HFP, PAVE and FAE, and in terms of achieving superior electrical characteristics (dielectric constant, dielectric loss tangent) and heat resistance, HFP and FAE are more preferred, and FAE is particularly desirable.

Examples of PAVE include CF₂=CFOR^{f1} (wherein R^{f1} is a perfluoroalkyl group of 1 to 10 carbon atoms that may include an oxygen atom between carbon atoms). Specific examples of PAVE include CF₂═CFOCF₂CF₃, CF₂═CFOCF₂CF₂CF₃ (hereinafter sometimes abbreviated as “PPVE”), CF₂═CFOCF₂CF₂CF₂CF₃, and CF₂═CFO(CF₂)₆F.

PPVE is preferred as the PAVE.

Examples of FAE include CH₂═CX³ (CF₂)_{q}X⁴ (wherein X³ represents a hydrogen atom or a fluorine atom, q is an integer of 2 to 10, and X⁴ represents a hydrogen atom or a fluorine atom).

Specific examples of FAE include CH₂═CF(CF₂)₂F, CH₂=CF(CF₂)₃F, CH₂=CF(CF₂)₄F, CH₂=CF(CF₂)₅F, CH₂=CF(CF₂)₆F, CH₂=CF(CF₂)₂H, CH₂=CF(CF₂)₃H, CH₂=CF(CF₂)₄H, CH₂=CF(CF₂)₅H, CH₂=CF(CF₂)₆H, CH₂═CH(CF₂)₂F, CH₂═CH(CF₂)₃F, CH₂═CH(CF₂)₄F, CH₂═CH(CF₂)₅F, CH₂═CH(CF₂)₆F, CH₂═CH(CF₂)₂H, CH₂═CH(CF₂)₃H, CH₂═CH(CF₂)₄H, CH₂═CH(CF₂)₅H, and CH₂═CH(CF₂)₆H.

The FAE is preferably CH₂═CH(CF₂)_{q}X⁴ (wherein q1 is an integer of 2 to 6, and preferably an integer of 2 to 4), is more preferably CH₂═CH(CF₂)₂F, CH₂═CH(CF₂)₃F, CH₂═CH(CF₂)₄F, CH₂=CF(CF₂)₃H, or CH₂=CF(CF₂)₄H, and is most preferably CH₂═CH(CF₂)₄F or CH₂═CH(CF₂)₂F.

Examples of the monomer having a functional group that forms the unit u2 include monomers having a carboxyl group (such as maleic acid, itaconic acid, citraconic acid and undecylenic acid), monomers having an acid anhydride group (such as itaconic anhydride (hereinafter sometimes abbreviated as “IAH”), citraconic anhydride (hereinafter sometimes abbreviated as “CAH”), 5-norbornene-2,3-dicarboxylic anhydride (hereinafter sometimes abbreviated as “NAH”), and maleic anhydride), and monomers having a hydroxyl group or an epoxy group (such as hydroxybutyl vinyl ether and glycidyl vinyl ether). A single monomer having a functional group may be used alone, or a combination of two or more such monomers may be used.

The monomer having a functional group that forms the unit u2 is preferably a monomer having an acid anhydride group, and is preferably at least one monomer selected from the group consisting of IAH, CAH and NAH, more preferably either IAH or NAH, and even more preferably IAH. By using at least one monomer selected from the group consisting of IAH, CAH and NAH, a fluorine-containing copolymer having acid anhydride groups can be produced easily, without using the special polymerization method that is required in those cases where maleic anhydride is used (see Japanese Unexamined Patent Application, First Publication No. Hei 11-193312).

The monomer having no fluorine that forms the unit u3 is preferably a compound having no fluorine but having one polymerizable carbon-carbon double bond, and specific examples include olefins (such as propylene and 1-butene, but excluding E) and vinyl esters (such as vinyl acetate). A single monomer having no fluorine may be used alone, or a combination of two or more such monomers may be used.

The preferred amount of each unit and the ratio between the units in the fluorine-containing copolymer are as follows.

The amount of the TFE unit relative to the total moles of all of the structural units of the fluorine-containing copolymer is preferably within a range from 30 to 70 mol %, more preferably from 35 to 65 mol %, and even more preferably from 40 to 60 mol %.

The amount of the E unit relative to the total moles of all of the structural units of the fluorine-containing copolymer is preferably within a range from 20 to 60 mol %, more preferably from 25 to 55 mol %, and even more preferably from 30 to 50 mol %.

The combined amounts of the TFE unit and the E unit relative to the total moles of all of the structural units of the fluorine-containing copolymer is preferably within a range from 80 to 100 mol %, more preferably from 85 to 99.5 mol %, and even more preferably from 90 to 99 mol %.

In the fluorine-containing copolymer, the TFE unit/E unit molar ratio is preferably within a range from 40/60 to 70/30, more preferably from 45/55 to 65/35, and even more preferably from 50/50 to 60/40.

In those cases where the fluorine-containing copolymer includes the unit u1, the amount of the unit u1 relative to the total moles of all of the structural units of the fluorine-containing copolymer is preferably within a range from 0.5 to 15 mol %, and more preferably from 1 to 10 mol %.

In those cases where the fluorine-containing copolymer includes the unit u2, the amount of the unit u2 relative to the total moles of all of the structural units of the fluorine-containing copolymer is preferably within a range from 0.05 to 1 mol %, and more preferably from 0.1 to 0.5 mol %.

In those cases where the fluorine-containing copolymer includes the unit u3, the amount of the unit u3 relative to the total moles of all of the structural units of the fluorine-containing copolymer is preferably 0 mol % from the viewpoint of the heat resistance, but if the unit u3 is included, the amount is preferably within a range from 0.001 to 1 mol %, and more preferably from 0.01 to 0.1 mol %.

In those cases where the fluorine-containing copolymer contains at least one of the units u1 to u3, the combined amounts of the unit u1 to unit u3 relative to the total moles of all of the structural units of the fluorine-containing copolymer is preferably within a range from 0.5 to 15 mol %, and more preferably from 1 to 10 mol %. In those cases where the fluorine-containing copolymer contains at least one of the units u1 to u3, the combined amounts of the TFE unit, the E unit, and the unit u1 to unit u3, relative to the total moles of all of the structural units of the fluorine-containing copolymer, is preferably at least 90 mol %, more preferably at least 95 mol %, and is even more preferably 100 mol %.

Provided the amount and proportion of each unit falls within the respective ranges above, the resulting rectangular wire exhibits superior surface smoothness of the coating film of the insulating coating material and enhanced conformability of the coating film of the insulating coating material to the rectangular conductor during bending deformation.

The proportion of each unit can be calculated by molten NMR analysis, fluorine content analysis, or infrared absorption spectroscopic analysis or the like of the fluorine-containing copolymer.

In the fluorine-containing copolymer, a portion of the acid anhydride groups in the units u2 may sometimes undergo hydrolysis, and as a result, the copolymer may contain a unit based on a dicarboxylic acid (such as itaconic acid, citraconic acid, 5-norbornene-2,3-dicarboxylic acid or maleic acid) that corresponds with an acid anhydride group-containing cyclic hydrocarbon monomer. In those cases where the copolymer includes such a unit based on a dicarboxylic acid, that unit is treated as a unit u2.

Preferred examples of the fluorine-containing copolymer include TFE/E/IFP copolymers, TFE/E/CH₂═CH(CF₂)₂F copolymers, TFE/E/CH₂═CH(CF₂)₄F copolymers, TFE/E/CH₂═CH(CF₂)₂F/CH₂═CH(CF₂)₄F copolymers, TFE/E/HFP/IAH copolymers, TFE/E/CH₂═CH(CF₂)₂F/IAH copolymers, TFE/E/CH₂═CH(CF₂)₄F/IAH copolymers, and TFE/E/CH₂═CH(CF₂)₂F/CH₂═CH(CF₂)₄F/IAH copolymers.

The MFR of the fluorine-containing copolymer at 297° C. is preferably within a range from 13 to 300 g/10 min., more preferably from 15 to 150 g/10 min., and even more preferably from 20 to 100 g/10 min.

The MFR of the fluorine-containing copolymer at 350° C. is preferably within a range from 25 to 350 g/10 min., more preferably from 50 to 300 g/10 min., and even more preferably from 80 to 250 g/10 min.

The fluorine-containing copolymer may be produced using conventional production methods, or a commercially available copolymer may be used. Examples of conventional production methods include the methods disclosed in International Patent Publication No. 2015/182702, International Patent Publication No. 2016/006644, and International Patent Publication No. 2016/017801.

### (Other Components)

The insulating coating material in the present invention may, if necessary, also contain one or more other components.

Examples of other components that may be included in the insulating coating material include fluorine-containing polymers other than the fluorine-containing copolymer containing the TFE unit and E unit, polymers containing no fluorine, crosslinking agents, antioxidants, fillers, plasticizers, flame retardants, pigments, and other additives. One of these other components may be used alone, or a combination of two or more other components may be used.

Specific examples of the fillers include fibrous fillers such as glass fiber, carbon fiber, boron fiber, aramid fiber, liquid crystalline polyester fiber, and stainless steel microfiber; and powder-like fillers such as talc, mica, graphite, molybdenum disulfide, polytetrafluoroethylene, calcium carbonate, silica, silica-alumina, alumina, and titanium dioxide. Other examples include hydrotalcites and metal oxides such as zinc oxide, magnesium oxide, titanium oxide and lead oxide. One or more inorganic fillers may be used.

Examples of the pigments include colored pigments such as organic pigments and inorganic pigments. Specific examples include carbon black (a black pigment), iron oxide (a red pigment), aluminum cobalt oxide (a blue pigment), copper phthalocyanine (a blue pigment or green pigment), perylene (a red pigment), and bismuth vanadate (a yellow pigment).

### [Crosslinking Agent]

The crosslinking agent has two or more unsaturated bonds per molecule. Examples of the crosslinking agent include triallyl cyanurate, triallyl isocyanurate, bismaleimide, ethylene glycol dimethacrylate, 1,4-butanediol dimethacrylate, trimethylolpropane trimethacrylate, and divinylbenzene. Among these, triallyl isocyanurate, which is commonly called TAIC, is preferred in terms of exhibiting high thermal stability.

The crosslinking agent is preferably included in an amount within a range from 0.5 to 20 parts by mass, and more preferably 2 to 8 parts by mass, per 100 parts by mass of the fluororesin.

The insulating coating material may contain an antioxidant. The antioxidant has at least one of a phenol group and a phosphorus atom, and has a molecular weight of at least 600.

The antioxidant preferably has both a phenol group and a phosphorus atom.

Ideal examples of the antioxidant are listed below, and an arbitrary combination of two or more of these antioxidants may also be used.

Examples of antioxidants having both a phenol group and a phosphorus atom include 2-tert-butyl-6-methyl-4-[3-(2,4,8,10-tetra-tert-butylbenzo[d][1,3,2]benzodioxaphosphepin-6-yl)oxypropyl]phenol, and phosphorus-modified novolac phenol-based resins.

Among the various possibilities, 2-tert-butyl-6-methyl-4-[3-(2,4,8,10-tetra-tert-butylbenzo[d][1,3,2]benzodioxaphosphepin-6-yl)oxypropyl]phenol is preferred in terms of offering excellent thermal stability.

Examples of antioxidants having a phenol group include bisphenol A, bisphenol AF, phenol, cresol, p-phenylphenol, m-phenylphenol, o-phenylphenol, allylphenol, p-hydroxybenzoic acid, ethyl p-hydroxybenzoate, and hindered phenols.

Examples of the hindered phenols include octadecyl 3-(3,5-di-tert-butyl-4-hydroxyphenyl)propanoate, octyl 3-(4-hydroxy-3,5-diisopropylphenyl)propionate, and bis[3-(3,5-di-tert-butyl-4-hydroxyphenyl)propionic acid][2,2-bis[[1-oxo-3-(3,5-di-tert-butyl-4-hydroxyphenyl)propoxy]methyl]propane]-1,3-diyl.

The antioxidant having a phosphorus atom preferably is preferably a phosphorus compound having a trivalent phosphorus atom.

Trivalent phosphorus atoms exist within the molecule in the form of a phosphine group or phosphonate ester group. Trivalent phosphorus undergoes self-oxidation to a pentavalent state, thereby preventing oxidation via a peroxide decomposition effect (eliminating the radicals generated from the peroxide).

Examples of antioxidants having a trivalent phosphorus atom include trioctyl phosphite, trilauryl phosphite, tridecyl phosphite, (octyl)diphenyl phosphite, tris(2,4-di-t-butylphenyl) phosphite, triphenyl phosphite, tris(butoxyethyl) phosphite, tris(nonylphenyl) phosphite, distearylpentaerythritol diphosphite, tetra(tridecyl)-1,1,3-tris(2-methyl-5-t-butyl-4-hydroxyphenyl)butane diphosphite, tetra(C12-C15 mixed alkyl)-4,4′-isopropylidenediphenyl diphosphite, tetra(tridecyl)-4,4′-butylidenebis(3-methyl-6-t-butylphenol) diphosphite, tris(3,5-di-t-butyl-4-hydroxyphenyl) phosphite, tris(mono- and di-mixed nonylphenyl) phosphite, hydrogenated 4,4′-isopropylidenediphenol polyphosphite, bis(octylphenyl)bis[4,4′-butylidenebis(3-methyl-6-t-butylphenol)]-1,6-hexanediol diphosphite, phenyl(4,4′-isopropylidenediphenol)pentaerythritol diphosphite, distearylpentaerythritol diphosphite, tris[4,4′-isopropylidene-bis(2-t-butylphenol)]phosphite, di(isodecyl)phenyl phosphite, 4,4′-isopropylidenebis(2-t-butylphenol)bis(nonylphenyl) phosphite, 9,10-dihydro-9-oxa-10-phosphaphenathrene-10-oxide, bis(2,4-di-t-butyl-6-methylphenyl)ethyl phosphite, 2-[{2,4,8,10-tetra-t-butyldibenz[d,f][1.3.2]-dioxa-phosphepin-6-yl}oxy]-N,N-bis[2-[{2,4,8,10-tetra-t-butyl-dibenz[d,f][1.3.2]dioxaphosphepin-6-yl}oxy]ethyl]-ethaneamine, 6-[3-(3-t-butyl-4-hydroxy-5-methylphenyl)propoxy]-2,4,8,10-tetra-t-butyldibenz[d,f][1.3.2]-dioxaphosphepin, and bis(dialkylphenyl)pentaerythritol diphosphite ester.

The antioxidant having a trivalent phosphorus atom may be a commercially available product. Examples of such commercially available products include Irgafos 168 (a registered trademark, manufactured by Ciba Specialty Chemicals, Inc.), Irgafos 12 (a registered trademark, manufactured by Ciba Specialty Chemicals, Inc.), Irgafos 38 (a registered trademark, manufactured by Ciba Specialty Chemicals, Inc.), ADK STAB 329K (a registered trademark, manufactured by Asahi Denka Kogyo K.K.), ADK STAB PEP36 (a registered trademark, manufactured by Asahi Denka Kogyo K.K.), ADK STAB PEP-8 (a registered trademark, manufactured by Asahi Denka Kogyo K.K.), Sandstab P-EPQ (a registered trademark, manufactured by Clariant AG), Weston 618 (a registered trademark, manufactured by GE Co., Ltd.), Weston 619G (a registered trademark, manufactured by GE Co., Ltd.), Ultranox 626 (a registered trademark, manufactured by GE Co., Ltd.), and Sumilizer GP (a registered trademark, manufactured by Sumitomo Chemical Co., Ltd.).

The antioxidant has a molecular weight of at least 600. The molecular weight of the antioxidant is preferably within a range from 600 to 50,000, and more preferably from 600 to 3,000.

Ensuring that the molecular weight of the antioxidant is at least 600 yields superior thermal stability. Provided the molecular weight of the antioxidant is no higher than the preferred upper limit value, the antioxidant exhibits excellent dispersibility within other polymer components.

The antioxidant is preferably added in an amount of 0.001 to 20 parts by mass, and more preferably 0.01 to 5 parts by mass, per 100 parts by mass of the fluorine-containing copolymer in the insulating coating material. Provided the amount of the antioxidant is at least as high as the preferred lower limit, the thermal stability is excellent. Provided the amount of the antioxidant is not more than the preferred upper limit, the mechanical properties are excellent.

Further, specific examples of other additives and the like such as fillers, plasticizers and flame retardants include those disclosed in paragraphs [0042] to [0048] of International Patent Publication 2019-198771.

Furthermore, fluororesins and fluorine-containing elastomers other than the fluorine-containing copolymer having the TFE unit and the E unit (hereinafter also referred to as the “ETFE”) may also be included as other components. The amount of any of these other resins is preferably less than 50% by mass, and more preferably less than 35% by mass, relative to the mass of the ETFE.

Examples of the fluororesins other than the ETFE include TFE/IFP copolymers (namely, copolymers having a TFE unit and an HFP unit, the same naming convention also applies below), TFE/HFP/PAVE copolymers, TFE/PAVE copolymers [PFA], E/TFE/IFP copolymers, polychlorotrifluoroethylene [PCTFE], CTFE/TFE copolymers, CTFE/TFE/PAVE copolymers, E/CTFE copolymers, TFE/VDF copolymers, VDF/IFP/TFE copolymers, VDF/HFP copolymers, polyvinylidene fluoride (PVDF), and polyvinyl fluoride (PVF).

Examples of the fluorine-containing elastomers include TFE/propylene (P) copolymers, HFP/VDF copolymers, and TFE/PAVE copolymers.

Among the various possibilities, fluorine-containing elastomers composed of TFE/P copolymers, HFP/VDF copolymers or TFE/PAVE copolymers are preferred.

In the rectangular wire of the present invention, if necessary, the insulating coating material containing a crosslinking agent may be subjected to crosslinking. Specifically, the insulating coating material may be irradiated with ionizing radiation such as γ-rays, an electron beam, or X-rays to achieve crosslinking. In terms of the equipment required, an electron beam is preferred as the radiation.

The crosslinking conditions depend on factors such as the shape and thickness of the molded body, and therefore cannot be generalized, but the crosslinking process is preferably conducted at least once in a temperature environment less than the melting point, and preferably no higher than the glass transition temperature, of the ETFE, and then at least once in a temperature environment equal to or higher than the melting point of the ETFE.

By first conducting crosslinking by irradiation of an electron beam in a temperature environment less than the melting point of the ETFE, melting and deformation of the insulating coating material is not observed when the insulating coating material is subjected to the second irradiation at a temperature equal to or higher than the melting point of the ETFE, meaning the shape of the insulating coating material can be maintained.

The radiation dosage is preferably within a range from 1 to 5,000 kGy, more preferably from 10 to 200 kGy, and even more preferably from 30 to 100 kGy.

In the rectangular wire of the present invention, in those cases where the insulating coating material containing a crosslinking agent is subjected to crosslinking, the evaluations of the MFR and shearing stress, and the winding test and the like described above are conducted following the crosslinking operations.

### <<Production Method for Rectangular Wire>>

The rectangular wire described above can be produced by a method that includes a step of forming the insulating coating material described above, using an extruder fitted with a die, by melting a fluorine-containing copolymer and extruding the melted fluorine-containing copolymer from the die around the periphery of a rectangular conductor so that the melted fluorine-containing copolymer coats the periphery of the rectangular conductor. The other components described above may also be supplied to the extruder in addition to the fluorine-containing copolymer.

Examples of the extruder include twin-screw extruders and single-screw extruders, but a twin-screw extruder is preferred.

The die opening has a rectangular shape.

The cylinder temperature and die temperature of the extruder are set in accordance with the type of fluorine-containing copolymer being used. The extruder cylinder temperature is preferably within a range from 50 to 450° C., more preferably from 80 to 440° C., and even more preferably from 90 to 430° C. The die temperature is preferably within a range from 100 to 420° C., more preferably from 120 to 400° C., and even more preferably from 150 to 380° C. By ensuring that the cylinder temperature and die temperature of the extruder are at least as high as the above lower limits, the mixability of the materials during kneading is more favorable. By ensuring that the cylinder temperature and die temperature of the extruder are no higher than the above upper limits, thermal degradation of the fluorine-containing copolymer can be more easily inhibited.

The residence time in the extruder is preferably at least 10 seconds but not longer than 30 minutes.

The extruder screw rotational rate is preferably within a range from 0.5 to 100 rpm.

The rectangular conductor is preferably preheated. The temperature of the preheated rectangular conductor is preferably within a range from 50 to 400° C., and more preferably from 80 to 250° C. There are no particular limitations on the preheating method used, and examples include optical heating, hot air heating, radiation heating, gas burner heating, and induction heating.

### (Draw Down Ratio)

In the production method for a rectangular wire according to one embodiment of the present invention, the draw down ratio (hereinafter also abbreviated as “DDR”) calculated using formula 1 below is preferably at least 0.1 but less than 10.0, and is more preferably within a range from 0.5 to 5, and even more preferably from 0.8 to 1.5.

Provided the DDR is at least as high as the above lower limit, a rectangular wire having superior surface smoothness of the coating film of the insulating coating material can be more easily obtained. Provided the DDR is less than (or not more than) the above upper limit, a rectangular wire having superior surface smoothness of the coating film of the insulating coating material and excellent conformability of the coating film of the insulating coating material to the rectangular conductor during bending deformation can be more easily obtained.

$$DDR = ( {D}_{A} - {C}_{A} ) / ( {F}_{A} - {C}_{A} ) \qquad Formula 1$$

In formula 1, D_{A} represents the area (mm²) of the die opening, C_{A} represents the area (mm²) of a cross-section of the rectangular conductor in a direction perpendicular to the axial direction, and F_{A} represents the area (mm²) of a cross-section of the rectangular wire in a direction perpendicular to the axial direction.

D_{A} can be determined from formula 2 shown below.

$${D}_{A} = {D}_{L} \times {D}_{S} \qquad Formula 2$$

In formula 2, D_{L} represents the inside dimension (mm) of the long side of the rectangular opening of the die, and D_{S} represents the inside dimension (mm) of the short side of the rectangular opening of the die.

C_{A} can be determined from formula 3 shown below.

$${C}_{A} = {C}_{L} \times {C}_{S} \qquad Formula 3$$

In formula 3, C_{L} represents the length (mm) of the long side of the rectangular cross-section of the rectangular conductor in a direction perpendicular to the axial direction, and C_{S} represents the length (mm) of the short side of the rectangular cross-section of the rectangular conductor in a direction perpendicular to the axial direction.

F_{A} can be determined from formula 4 shown below.

$${F}_{A} = {F}_{L} \times {F}_{S} \qquad Formula 4$$

In formula 4, F_{L} represents the length (mm) of the long side of the rectangular cross-section of the rectangular wire in a direction perpendicular to the axial direction, and F_{S} represents the length (mm) of the short side of the rectangular cross-section of the rectangular conductor in a direction perpendicular to the axial direction.

In one embodiment of the present invention, molding of the insulating coating material is preferably conducted under pressure, namely by employing a pressure molding method. By using a pressure molding method, the DDR can be adjusted to a value less than (or not more than) the above upper limit more easily than the case of a conventional tube molding method, and as a result, a rectangular wire that exhibits excellent surface smoothness of the coating film of the insulating coating material and excellent conformability of the coating film of the insulating coating material to the rectangular conductor during bending deformation can be more easily obtained.

### (Uses)

The rectangular wire of the present invention can be used favorably, for example, in isolated amplifiers, isolation transformers, vehicle alternators, and the electric motors of hybrid vehicles, electrically powered ships, electrically powered aircraft, and electrically powered vertical take-off and landing aircraft. Further, the rectangular wire of the present invention can also be used for all manner of wiring (such as wrapping wiring, vehicle wiring, and robot wiring) and wound coils (magnetic wiring).

### EXAMPLES

The present invention is described below in further detail using a series of examples, but the present invention is not limited to these examples. Among the following examples, Examples 1, 3, 5, 7, and 11 to 15 represent examples of the present invention, and Examples 2, 4, 6, and 8 to 10 represent comparative examples.

### <Evaluation Methods>

### (MFR of Fluorine-Containing Copolymer and Insulating Coating Material)

Following preheating of the insulating coating material for 5 minutes, the MFR at 49 N was measured in accordance with JIS K 7210-1:2014. Measurements were conducted at 297° C. and 350° C. In Table 1, MFR1 means the measurement results at 297° C. and MFR2 means the measurement results at 350° C.

### (Shearing Stress of Insulating Coating Material)

The shearing stress was measured in accordance with JIS K 7199:1999. Specifically, measurements were conducted using the method (using a capillary die) disclosed in paragraphs [0073] to [0075] and [0079] to [0081] of Japanese Unexamined Patent Application, First Publication No. 2015-086364.

### (Average Thickness of Coating Film and Thickness Variation)

The thickness of the coating film of the insulating coating material on the long side of a rectangular cross-section in a direction perpendicular to the axial direction (only on the side that contacts the upper inner surface of the die during molding) was measured every 100 mm for a rectangular wire of length 5 m.

The value obtained by calculating the arithmetic mean of the measured values (mm) was recorded as the average thickness.

The unbiased standard deviation of the measured values was recorded as the thickness variation.

### (Winding Test)

The rectangular wire was evaluated by conducting a winding test in accordance with JIS 3216-3:2011, section 5.1.2 “Rectangular Wires”. The cross-section of the rectangular wire was inspected visually, and an evaluation was made against the following criteria.

A: no detachment of the coating film of the insulating coating material from the rectangular conductor.

B: detachment of the coating film of the insulating coating material from the rectangular conductor.

### (Conformability)

For each rectangular wire, bending deformation was conducted in both in the edgewise direction and the flatwise direction. The deformation angle was set to 90±10°. Subsequently, the surface of the coating film of the insulating coating material and the cross-section of the rectangular wire in a portion that had undergone bending deformation were inspected visually, and the conformability was evaluated against the following criteria.

A: no wrinkling occurred on the surface of the coating film of the insulating coating material during bending, and no detachment of the coating film of the insulating coating material from the rectangular conductor occurred.

B: wrinkling occurred on the surface of the coating film of the insulating coating material during bending, or detachment of the coating film of the insulating coating material from the rectangular conductor occurred.

### <Surface Smoothness>

The surface roughness (Ra) of the rectangular wire was measured using a digital microscope (HIRX-1 manufactured by Hirox Co., Ltd.) Measurements were conducted at 80× magnification along a measurement length of 4 mm.
A: surface roughness of 10 μm or less
B: surface roughness greater than 10 μm but not more than 45 μm
C: surface roughness greater than 45 μm

### <Scrape Abrasion Test>

Each obtained rectangular wire was cut to a length of 2 m to generate a sample test piece, and a scrape abrasion test was conducted in accordance with the test method prescribed in ISO 6722-1 using a Magnet Wire Abrasion Tester (reciprocating type) manufactured by Yasuda Seiki Seisakusho, Ltd. Specifically, testing was conducted under conditions including a needle diameter of 0.45±0.01 mm, a needle material of SUS316 (prescribed in JIS K-G7602), and abrasion length of 15.5±1 mm, and abrasion speed of 55±5 repetitions/minute, a load of 7 N, and a test environment at 23±1° C. The abrasion resistance is measured by moving the needle back and forth, and is represented by the number of back and forth repetitions necessary until the conductor is exposed through the insulating coating. A larger abrasion resistance (higher number of repetitions) means superior abrasion resistance for the insulating layer.

### (Materials Used)

Fluorine-containing copolymer 1: a fluorine-containing copolymer having a molar ratio of TFE units:E units:HFP units:C4 units:IAH units=47.5:43.4:8.3:0.6:0.3 (MFR at 297° C.=70 g/10 min., MFR at 350° C.=246.2 g/10 min.)

Fluorine-containing copolymer 2: a fluorine-containing copolymer having a molar ratio of TFE units:E units:C2 units:C4 units:IAH units=58.1:38.8:0.4:2.6:0.1 (MFR at 297° C.=25 g/10 min., MFR at 350° C.=93.7 g/10 min.)

Fluorine-containing copolymer 3: a fluorine-containing copolymer having a molar ratio of TFE units:E units:C4 units=60:40:3.3 (MFR at 297° C.=25 g/10 min., MFR at 350° C.=113.8 g/10 min.)

Fluorine-containing copolymer 4: a fluorine-containing copolymer having a molar ratio of TFE units:E units:C4 units=54:46:1.4 (MFR at 297° C.=33 g/10 min., MFR at 350° C.=157 g/10 min.)

Fluorine-containing copolymer 5: a fluorine-containing copolymer having a molar ratio of TFE units:E units:C4 units=53.5:45.6:0.9 (MFR at 297° C.=7 g/10 min., MFR at 350° C.=20.8 g/l0 min.)

The C2 unit is CH₂═CH(CF₂)₂F, and the C4 unit is CH₂═CH(CF₂)₄F.

Crosslinking agent: triallyl isocyanurate (TAIC) manufactured by Mitsubishi Chemical Corporation

Antioxidant A: Sumilizer GP, manufactured by Sumitomo Chemical Co. Ltd.

Antioxidant B: Irganox 1010, manufactured by BASF SE.

### Example 1

The fluorine-containing copolymer 1 was subjected to electric wire extrusion molding under the conditions listed below to produce a rectangular wire. The DDR was set to 1. In the electric wire extrusion molding, a so-called pressure molding method was employed in which formation of the insulating coating material was conducted under pressure.
Die temperature: 270° C.
Cylinder temperature: 160 to 270° C.
Rectangular conductor: a rectangular copper wire of thickness: 1.5 mm×width: 2.3 mm
Rectangular conductor preheating temperature: 185° C.
Coating thickness (set value): 0.18 mm

### Example 2

With the exception of altering the DDR to 15, a rectangular wire was produced in the same manner as Example 1. However, in the electric wire extrusion molding, a so-called tube molding method was employed in which formation of the insulating coating material was conducted at substantially normal pressure.

### Example 3

The fluorine-containing copolymer 2 was subjected to electric wire extrusion molding under the conditions listed below to produce a rectangular wire. The DDR was set to 1. In the electric wire extrusion molding, a so-called pressure molding method was employed in which formation of the insulating coating material was conducted under pressure.
Die temperature: 350° C.
Cylinder temperature: 210 to 350° C.
Rectangular conductor: a rectangular copper wire of thickness: 1.5 mm×width: 2.3 mm
Rectangular conductor preheating temperature: 195° C.
Coating thickness (set value): 0.18 mm

### Example 4

With the exception of altering the DDR to 15, a rectangular wire was produced in the same manner as Example 3. However, in the electric wire extrusion molding, a so-called tube molding method was employed in which formation of the insulating coating material was conducted at substantially normal pressure.

### Examples 5, 7, 9

With the exceptions of using the fluorine-containing copolymers shown in Table 1 instead of the fluorine-containing copolymer 2, and adjusting the preheating temperature for the rectangular conductor to 200° C., rectangular wires were produced in the same manner as Example 3.

### Examples 6, 8, 10

With the exceptions of using the fluorine-containing copolymers shown in Table 1 instead of the fluorine-containing copolymer 2, and adjusting the preheating temperature for the rectangular conductor to 200° C., rectangular wires were produced in the same manner as Example 4.

The insulating coating material and rectangular wire of each example were subjected to the evaluations described above. The results are shown in Table 1.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| Fluorine-containing copolymer | | 1 | 1 | 2 | 2 | 3 | 3 | 4 | 4 | 5 | 5 |
| Insulating | MFR1 | 81 | 78.2 | 31 | 31 | 43 | 42 | 50 | 48 | 11.5 | 9.85 |
| coating | [g/10 min.] | | | | | | | | | | |
| material | MFR2 | 201 | 194.5 | 94 | 92 | 139 | 130 | 167 | 162 | 39 | 36.8 |
| | [g/10 min.] | | | | | | | | | | |
| | Shearing stress | 11 | 9 | 37 | 37 | 27 | 28 | 25 | 25 | 110 | 109 |
| | [kPa] | | | | | | | | | | |
| Coating | Average | 0.184 | 0.181 | 0.182 | 0.195 | 0.184 | 0.201 | 0.181 | 0.212 | 0.243 | 0.279 |
| film | thickness [mm] | | | | | | | | | | |
| | Thickness | 0.016 | 0.071 | 0.011 | 0.084 | 0.020 | 0.073 | 0.023 | 0.106 | 0.128 | 0.161 |
| | variation [mm] | | | | | | | | | | |
| Rectangular | Winding test | A | B | A | B | A | B | A | B | B | B |
| wire | Conformability | A | B | A | B | A | B | A | B | B | B |
| | Surface | A | C | A | C | A | C | B | C | C | C |
| | smoothness | | | | | | | | | | |

Examples 1, 3, 5 and 7 exhibited excellent results for the winding test (durability), surface smoothness of the coating film of the insulating coating material, and conformability of the coating film of the insulating coating material to the rectangular conductor during bending deformation.

In contrast, in Examples 2, 4, 6, 8 and 10 in which the DDR was set to 15, the results for the winding test (durability) and the conformability of the coating film of the insulating coating material to the rectangular conductor during bending deformation were inferior.

In Example 9 in which the MFR of the insulating coating material at 297° C. was less than 13 g/10 min., even with the DDR set to 1, the surface smoothness of the coating film of the insulating coating material, and the conformability of the coating film of the insulating coating material to the rectangular conductor during bending deformation were inferior.

### Examples 11 to 14

Fluorine-containing resin compositions of the formulations shown in Table 2 were melt kneaded using a twin-screw extruder (032, Twin Screw Extruder manufactured by Technovel Corporation) to obtain pellets. The kneading conditions included a cylinder temperature of 280 to 300° C., a die temperature of 300° C., and a screw rotational rate of 200 rpm.

With the exceptions of using each of the pellets described above instead of the fluorine-containing copolymer 2, and setting the preheating temperature for the rectangular conductor to 200° C., rectangular wires were produced in the same manner as Example 3.

Each rectangular wire was then irradiated with an electron beam using the irradiation dose shown in Table 2, thus completing production of rectangular wires of Examples 11 to 14.

The insulating coating material and rectangular wire of each example were subjected to the evaluations described above (with the evaluations of MFR, shearing stress, conformability and the winding test all conducted after crosslinking). The results are shown in Table 2.

### Example 15

A fluorine-containing resin composition of the formulation shown in Table 2 was melt kneaded using a twin-screw extruder (o32, Twin Screw Extruder manufactured by Technovel Corporation) to obtain pellets. The kneading conditions included a cylinder temperature of 280 to 300° C., a die temperature of 300° C., and a screw rotational rate of 200 rpm.

With the exception of using the pellets described above instead of the fluorine-containing copolymer 2, a rectangular wire was produced in the same manner as Example 3.

The rectangular wire was then irradiated with an electron beam using the irradiation dose shown in Table 2, thus completing production of a rectangular wire of Example 15.

The insulating coating material and rectangular wire were subjected to the evaluations described above (with the evaluations of MFR, shearing stress, conformability and the winding test all conducted after cosslinking). The results are shown in Table 2.

TABLE 2

| | | Example | Example | Example | Example | Example |
|---|---|---|---|---|---|---|
| | | 11 | 12 | 13 | 14 | 15 |
| Fluorine- | Fluorine-containing | 95 | 95 | 100 | 95 | — |
| containing resin | copolymer 4 | | | | | |
| composition | Fluorine-containing | — | — | — | — | 95 |
| (parts by mass) | copolymer 2 | | | | | |
| | Crosslinking agent | 5 | 4.98 | — | 4.5 | 4.98 |
| | Antioxidant A | — | 0.02 | — | — | 0.02 |
| | Antioxidant B | — | — | — | 0.5 | — |
| Irradiation dose (kGy) | | 100 | 200 | 100 | 200 | 100 |
| MFR1 | | 51 | 43 | 50 | 43 | 71 |
| MFR2 | | 147 | 140 | 167 | 140 | 165 |
| Coating film | Average thickness [mm] | 120 | 120 | 120 | 120 | 120 |
| | Thickness variation [mm] | 0.02 | 0.02 | 0.02 | 0.02 | 0.02 |
| Rectangular | Winding test | A | A | A | A | A |
| wire | Conformability | A | A | A | A | A |
| | Surface smoothness | A | A | A | A | A |
| Abrasion | Scrape abrasion test | 2642 | 3135 | 1990 | 2731 | 2186 |
| resistance | [repetitions] | | | | | |
| Surface | Surface roughness Ra | 9.1 | 10.1 | 6.8 | 8.1 | 9.2 |
| roughness | [μm] | | | | | |

In Examples 11 to 15, in addition to superior results for the winding test (durability), the surface smoothness of the coating film of the insulating coating material, and the conformability of the coating film of the insulating coating material to the rectangular conductor during bending deformation, the rectangular wires also exhibited excellent abrasion resistance.

### INDUSTRIAL APPLICABILITY

The present invention is able to provide a rectangular wire that can be produced with good productivity, and exhibits excellent surface smoothness of the coating film of the insulating coating material and excellent conformability of the coating film of the insulating coating material to the rectangular conductor during bending deformation, as well as providing a production method for the rectangular wire.

1. A rectangular wire comprising a rectangular conductor having a rectangular cross-section in a direction perpendicular to an axial direction, and a coating film of an insulating coating material formed by extrusion molding that directly covers the rectangular conductor around an entire peripheral direction, wherein
a melt flow rate of the insulating coating material at 297° C. is within a range from 13 to 150 g/10 min., an average thickness of the coating film of the insulating coating material is within a range from 10 to 1,000 μm, an unbiased standard deviation of the thickness of the coating film of the insulating coating material along an axial direction of the rectangular wire is less than 0.06 mm,
the insulating coating material contains a fluorine-containing copolymer having a tetrafluoroethylene-based unit and an ethylene-based unit, and
in a winding test of the rectangular wire conducted in accordance with JIS 3216-3:2011, section 5.1.2 “Rectangular Wires”, the coating film of the insulating coating material does not detach from the rectangular conductor.

2. The rectangular wire according to claim 1, wherein a cross-sectional area of the rectangular conductor is 2.6 mm² or greater.

3. The rectangular wire according to claim 1, wherein the insulating coating material contains a crosslinking assistant having a plurality of unsaturated carbon bonds.

4. The rectangular wire according to claim 3, wherein the insulating coating material is a crosslinked product having a crosslinked structure formed by the crosslinking assistant.

5. The rectangular wire according to claim 4, wherein a result for a scrape abrasion test conducted in accordance with ISO 6722-1 is 2,000 repetitions or higher.

6. A production method for a rectangular wire comprising a rectangular conductor having a rectangular cross-section in a direction perpendicular to an axial direction, and a coating film of an insulating coating material formed by extrusion molding that directly covers the rectangular conductor around an entire peripheral direction,
the production method comprising a step of forming the insulating coating material, using an extruder fitted with a die, by melting a fluorine-containing copolymer and extruding the melted fluorine-containing copolymer from the die around a periphery of the rectangular conductor so that the melted fluorine-containing copolymer coats the periphery of the rectangular conductor, wherein
a melt flow rate of the insulating coating material at 297° C. is within a range from 13 to 150 g/10 min., an average thickness of the coating film of the insulating coating material is within a range from 10 to 1,000 μm, an unbiased standard deviation of the thickness of the coating film of the insulating coating material along an axial direction of the rectangular wire is less than 0.06 mm,
the fluorine-containing copolymer has a tetrafluoroethylene-based unit and an ethylene-based unit, and
in a winding test of the rectangular wire conducted in accordance with JIS 3216-3:2011, section 5.1.2 “Rectangular Wires”, the coating film of the insulating coating material does not detach from the rectangular conductor.

7. The production method according to claim 6, wherein a draw down ratio DDR calculated using formula 1 below is at least 0.5 but less than 10.0:
$$DDR = ( {D}_{A} - {C}_{A} ) / ( {F}_{A} - {C}_{A} ) \qquad Formula 1$$
wherein in formula 1, D_{A} represents an area (mm²) of an opening of the die, C_{A} represents an area (mm²) of a cross-section of the rectangular conductor in a direction perpendicular to an axial direction, and F_{A} represents an area (mm²) of a cross-section of the rectangular wire in a direction perpendicular to an axial direction.

8. The production method for a rectangular wire according to claim 6, wherein a cross-sectional area of the rectangular conductor is 2.6 mm² or greater.
